(19) United States
(12) Patent Application Publication
(10) Pub. No.: US 2025/0137395 A1
(43) Pub. Date: May 1, 2025

(54) COLD START CATALYST BYPASS SYSTEM

(71) Applicant: FCA US LLC, Auburn Hills, MI (US)

(72) Inventors: Jeff Brand, Highland, MI (US); Ryan Sturgeon, Rochester Hills, MI (US); Brett M Schubring, Macomb, MI (US); Michael P Schmidt, Highland, MI (US)

(21) Appl. No.: 18/496,023

(22) Filed: Oct. 27, 2023

(51) Int. Cl. F01N 3/28; F01N 11/00; F01N 13/10; F02B 37/22

(52) U.S. Cl. CPC F01N 3/2892; F01N 11/002; F01N 13/10; F02B 37/22

(57) ABSTRACT

An internal combustion engine system includes an internal combustion engine and a main exhaust aftertreatment system with a main catalytic converter configured to receive exhaust gas from the internal combustion engine. A variable geometry turbine (VGT) includes a plurality of vanes movable between a normal operation position and a restricted position. A light-off catalyst bypass system includes a bypass passage and a bypass catalytic converter configured to selectively receive exhaust gas from the internal combustion engine and bypass the VGT. During cold start, long idle, and/or low main catalytic converter temperature conditions, the plurality of vanes are moved to the restricted position to restrict or prevent exhaust gas from flowing through the VGT to facilitate directing the exhaust gas through the bypass passage and the bypass catalyst.

### FIELD

The present application relates generally to internal combustion engine aftertreatment systems and, more particularly, to an internal combustion engine having a light-off catalyst bypass system.

### BACKGROUND

In conventional internal combustion aftertreatment systems it is difficult to achieve low tailpipe emissions in the time immediately following a cold engine start due to low catalyst conversion efficiency of cold catalysts. In order to achieve acceptable conversion efficiency, the catalyst must surpass a predetermined light-off temperature. In some systems, faster light-off temperatures may be achieved, but often at the cost of high exhaust system backpressure, durability, longevity, cost, and/or complexity. Thus, while such conventional systems do work well for their intended purpose, it is desirable to provide continuous improvement in the relevant art.

### SUMMARY

In accordance with one example aspect of the invention, an internal combustion engine system is provided. In one example implementation, the engine system includes an internal combustion engine and a main exhaust aftertreatment system with a main catalytic converter configured to receive exhaust gas from the internal combustion engine. A variable geometry turbocharger (VGT) turbine includes a plurality of vanes movable between a normal operation position and a restricted position. A light-off catalyst bypass system includes a bypass passage and a bypass catalytic converter configured to selectively receive exhaust gas from the internal combustion engine and bypass the VGT turbine. During cold start, long idle, and/or low main catalytic converter temperature conditions, the plurality of vanes are moved to the restricted position to restrict or prevent exhaust gas from flowing through the VGT turbine to facilitate directing the exhaust gas through the bypass passage and the bypass catalyst.

In addition to the foregoing, the described engine system may include one or more of the following features: an exhaust manifold configured to supply exhaust gas through a main outlet duct, through the VGT turbine, and to the main exhaust aftertreatment system and the main catalytic converter, wherein the bypass passage is in fluid communication with the exhaust manifold; a bypass valve configured to move between a first position that enables exhaust gas to flow through the bypass passage, and a second position that prevents exhaust gas flow through the bypass passage and bypass catalytic converter; and wherein the bypass valve is moved to the first position when the plurality of vanes is moved to the restricted position.

In addition to the foregoing, the described engine system may include one or more of the following features: wherein the bypass valve is moved to the second position when the plurality of vanes is moved to the normal operation position; a controller in signal communication with the VGT and configured to move the plurality of vanes between the restricted position and the normal operation position; wherein the controller is in signal communication with the bypass valve and configured to move the bypass valve between the first and second positions; and wherein the restricted position prevents flow of exhaust gas through the VGT turbine.

In accordance with another example aspect of the invention, a method of operating an internal combustion engine system is provided. In one example implementation, the engine system includes an internal combustion engine and a main exhaust aftertreatment system with a main catalytic converter configured to receive exhaust gas from the internal combustion engine. A variable geometry turbocharger (VGT) turbine includes a plurality of vanes movable between a normal operation position and a restricted position. A light-off catalyst bypass system includes a bypass passage and a bypass catalytic converter configured to selectively receive exhaust gas from the internal combustion engine and bypass the VGT turbine.

In one example, the method includes monitoring, by the controller, a temperature of the main catalytic converter to determine if the temperature is below a predetermined light-off temperature; and moving, by the controller, the plurality of vanes to the restricted position when the temperature is below the predetermined light-off temperature to restrict or prevent exhaust gas from flowing through the VGT turbine to facilitate directing the exhaust gas through the bypass passage and the bypass catalyst.

In addition to the foregoing, the described method may include one or more of the following features: wherein the internal combustion engine system further includes an exhaust manifold configured to supply exhaust gas through a main outlet duct, through the VGT turbine, and to the main exhaust aftertreatment system and the main catalytic converter, and wherein the bypass passage is in fluid communication with the exhaust manifold; and wherein the internal combustion engine system further includes a bypass valve configured to move between a first position that enables exhaust gas to flow through the bypass passage, and a second position that prevents exhaust gas flow through the bypass passage and bypass catalytic converter.

In addition to the foregoing, the described method may include one or more of the following features: moving the bypass valve, by the controller, to the first position when the temperature is below the predetermined light-off temperature to enable exhaust gas to flow through the bypass passage; moving the bypass valve, by the controller, to the second position when the temperature exceeds the predetermined light-off temperature to prevent exhaust gas to flow through the bypass passage; moving the plurality of vanes, by the controller, to the normal operating position when the temperature exceeds the predetermined light-off temperature to enable exhaust gas to flow through the VGT turbine; and wherein the restricted position prevents flow of exhaust gas through the VGT turbine.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic diagram of an example light-off catalyst bypass system in accordance with the principles of the present application; and

FIG. 2 is a flow control diagram of an example method of operating the light-off catalyst bypass system in FIG. 1, in accordance with the principles of the present application.

### DESCRIPTION

As previously described, some conventional aftertreatment systems have limited or no capacity to get the catalyst to a light-off temperature for efficient conversion of harmful exhaust constituents before approximately fifteen seconds post cold start in a turbocharged system. Every second the engine is running and the catalyst is not at or above light-off temperature, CO HC, and NOx are not being converted efficiently. The short time preceding the catalyst light-off is responsible for a very large portion of the CO, HC, and NOx breakthrough for on and off cycle starts and long idles. In conventional systems, one or more catalysts are traditionally located some distance downstream of the exhaust outlet of the heat and/or turbocharger outlet and are typically in the main exhaust flow for the entire useful life of the vehicle.

Accordingly, described herein are systems and methods for a light-off catalyst bypass system for improving exhaust emissions during start-up of an internal combustion engine. The system utilizes specially designed vanes of a variable geometry turbocharger (VGT) as a restriction (e.g., valve) and an exhaust bypass with a small auxiliary catalyst with a shut-off valve. During a cold start, long idle, and/or low main catalyst temperatures, the VGT vanes are actuated for maximum flow restriction through the turbine to route the exhaust gases to the auxiliary catalyst instead of through the turbine before it re-enters the main exhaust path. This allows for rapid catalyst light-off and improved conversion of harmful exhaust constituents without requiring an additional, separate valve system to block flow through the turbine.

In one example, the system described herein utilizes a VGT that includes a compressor, turbine housing, turbine, rack/vane system, and a shaft that connects the compressor and turbine. The electrically actuated VGT rack/vanes are utilized in combination with a bypass catalyst system that includes a bypass passage, an auxiliary bypass catalyst, and a bypass valve for blocking off flow into the bypass passage. The inlet of the bypass passage is located upstream of the turbine inlet as close as possible to the exhaust ports or cylinder head to minimize heat losses in the exhaust gas. Because of its small size and low surface area/distance from the exhaust valves, the auxiliary bypass catalyst warms up more rapidly than a conventional catalyst.

During a cold engine start-up event or other situation where it is desirable to have the exhaust gas flow through the bypass catalyst system, the VGT vane rack is rotated to limit turbine flow and the bypass valve is opened. The vane positions limit turbine flow and drive the exhaust gas through the bypass passage, thereby bypassing the turbine without the need for a separate and much larger valve system. Limiting flow from proceeding directly through the turbine and to the conventional main catalyst during cold start is desirable because the main catalyst cannot effectively convert exhaust constituents before it reaches the light-off temperature.

The exhaust exiting the bypass catalyst is directed at the inlet of the main catalyst to assist in heating the main catalyst to the light-off temperature. Once the main catalyst light-off is achieved, the vane position is rotated to achieve the desired turbine speed/torque request, and the bypass valve or other means is utilized to stop flow through the bypass catalyst system, thus allowing normal engine operation to commence.

Advantages of the system include: extremely fast catalyst light-off times, the ability to selectively drive most or all of the exhaust flow through a bypass catalyst before going through the main exhaust path; extremely short distance, surface area, and thermal mass between the exhaust ports and the bypass catalyst via bypassing the turbocharger turbine; the ability to deactivate the bypass catalyst after light-off; extremely high cell density substrate in the catalyst that would not be used in a non-bypassable system due to excessive backpressure; and the ability to move PGM (platinum group metals) away from the main catalyst and onto the bypass catalyst for better PGM utilization.

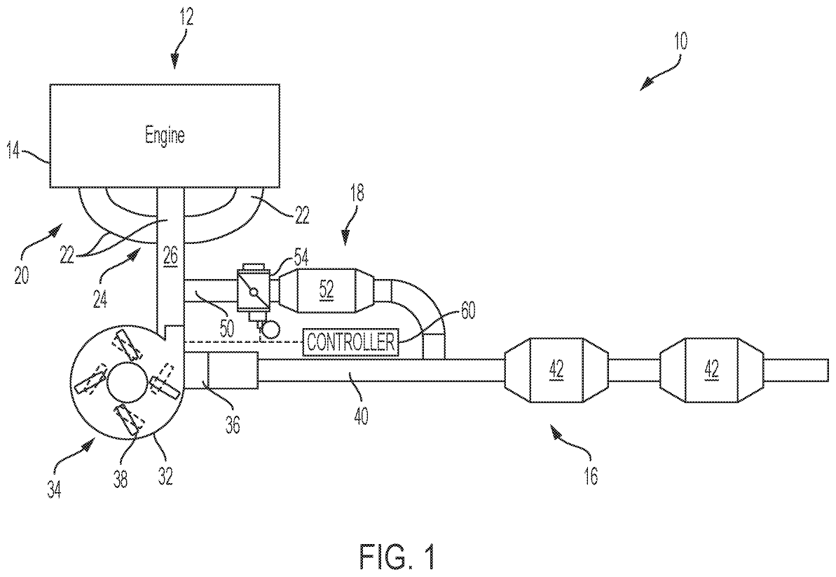

With initial reference to FIG. 1, an internal combustion engine system 10 having an internal combustion engine 12 with a cylinder head 14 is illustrated in accordance with the principles of the present application. In the example embodiment, the cylinder head 14 is configured to selectively supply exhaust gas to a main exhaust aftertreatment system 16 and a light-off catalyst bypass system 18. As described herein in more detail, the light-off catalyst bypass system 18 is selectively utilized during cold start, long idle, and/or cold catalyst conditions to rapidly heat to light-off temperatures to quickly achieve low tailpipe emissions.

As shown in FIG. 1, the engine system 10 further includes an exhaust manifold 20 having a plurality of cylinder exhaust passages 22 that merge together to form a collector portion or main exhaust passage 24 having an outlet 26. In some embodiments, the exhaust manifold 20 may be coupled (e.g., bolted) to the cylinder head 14 or alternatively integrated therein. A main outlet duct receives exhaust gas from the manifold outlet 26 and is configured to direct the exhaust gas to the main exhaust aftertreatment system 16 via a turbine 32 of a variable geometry turbocharger (VGT) 34. As described herein in more detail, the VGT turbine 32 includes a volute 36 with a plurality of vanes 38 movable between a restricted position (shown in solid) and normal, non-restrictive positions (shown in phantom). In one embodiment, the restricted position completely blocks flow through the volute 36.

In the example embodiment, the main exhaust aftertreatment system 16 generally includes a main exhaust conduit 40 having one or more main catalytic converters 42 to reduce or convert a desired exhaust gas constituent such as, for example, carbon monoxide (CO), hydrocarbon (HC), and/or nitrogen oxides (NOx). The main exhaust conduit 40 is fluidly coupled to the exhaust manifold main outlet 26 via the VGT turbine 32 and is configured to receive exhaust gas from the vehicle engine 12 and supply the exhaust gas to the main catalytic converter 42. In order to efficiently reduce or convert CO, HC, and NOx, the main catalytic converter 42 must reach a predetermined light-off temperature. However, during some vehicle operations such as cold starts, the main catalytic converter 42 is below light-off temperature and therefore has a low catalyst conversion efficiency.

In order efficiently reduce or convert the unwanted exhaust gas constituents while the main catalytic converter 42 is below the light-off temperature, the vehicle utilizes the light-off catalyst bypass system 18, which generally includes a bypass passage 50, a bypass catalytic converter (“bypass catalyst”) 52, and a bypass valve 54. The light-off catalyst bypass system 18 is configured to redirect at least a portion of the exhaust gas from the exhaust manifold 20, into the bypass passage 50, and through the auxiliary bypass catalyst 52. Because the bypass catalyst 52 is located close to the cylinder head 14, it is in close proximity to the engine combustion chambers and receives the exhaust gas quicker and at a higher temperature than the main catalytic converter 42 would. Thus, the bypass catalyst 52 is rapidly heated to its predetermined light-off temperature to achieve high catalyst conversion efficiency before the main catalytic converter 42 alone. It will be appreciated that the light-off catalyst bypass system 18 may have various configurations and be integrated with or into the cylinder head 14 in various manners. Some example configurations are shown and described in commonly owned U.S. patent application Ser. No. 17/158,258, filed Jan. 26, 2021 and U.S. patent application Ser. No. 18/309,382, filed Apr. 28, 2023, the entire contents of which are incorporated herein by reference thereto.

A controller 60 (e.g., engine control unit) is in signal communication with the bypass valve 54 and the VGT turbine 32. The controller 60 is configured to move the bypass valve 54 to any position between a fully open first position and a fully closed second position. In the first position, the bypass valve 54 enables exhaust gas to flow through the bypass passage 50 and thus the bypass catalyst 52. In the second position, the bypass valve 54 prevents exhaust gas from flowing through the bypass passage 50 and bypass catalyst 52. Although illustrated in the example implementation as a butterfly valve, it will be appreciated that bypass valve 54 may be any suitable valve that enables light-off catalyst bypass system 18 to operate as described herein.

Additionally, the controller 60 is configured to move the VGT vanes 38 between a restricted position (in solid, FIG. 1) and one or more normal operation positions (in phantom). In the restricted position, the VGT vanes 38 restrict or prevent exhaust gas from flowing through the turbine 32 to facilitate directing the exhaust gas through the bypass passage 50 and bypass catalyst 52. In the one or more normal operation positions, exhaust gas is allowed to flow through the turbine 32 in a normal manner.

In one example, the bypass catalyst 52 is a three-way catalyst configured to remove CO, HC, and NOx from the exhaust gas passing therethrough, as described herein in more detail. However, it will be appreciated that bypass catalyst 52 may be any suitable catalyst that enables light-off catalyst bypass system 18 to remove any desired pollutant or compound such as, for example, a hydrocarbon trap or a four-way catalyst. In another example, bypass catalyst 52 has a cell density of between approximately 800 and approximately 1200 cells per square inch, or between 800 and 1200 cells per square inch.

In the example embodiment, the light-off catalyst bypass system 18 is configured to selectively operate in (i) a normal or warm catalyst mode and (ii) a cold catalyst mode. In the warm catalyst mode, controller 60 determines the main catalytic converter 42 has reached the predetermined light-off temperature (e.g., via temperature sensor, modeled, etc.) and moves the bypass valve 54 to the fully closed position and the VGT vanes 38 to the normal operating position. In this mode, the bypass valve 54 facilitates preventing the exhaust gas in the exhaust manifold 20 from entering the bypass passage 50 and thus bypass catalyst 52. Instead, the exhaust gas is directed through main exhaust passage 24, the VGT turbine 32, into the main exhaust conduit 40, and through the main catalytic converter 42 before being exhausted to the atmosphere.

In the cold catalyst mode, controller 60 determines the main catalytic converter 42 is below the predetermined light-off temperature (e.g., a cold start), and subsequently moves the bypass valve 54 to the fully open position and the VGT vanes 38 to the restricted (e.g., closed) position. In this mode, the VGT vanes 38 restrict or prevent exhaust gas from passing through the VGT turbine 32. Instead, the open bypass valve 54 enables the exhaust gas to be directed through bypass passage 50 and bypass catalyst 52 before being directed to the main exhaust conduit 40 and atmosphere. Once the main catalytic converter 42 has reached the light-off temperature, the controller 60 may then switch the light-off catalyst bypass system 18 to the normal mode.

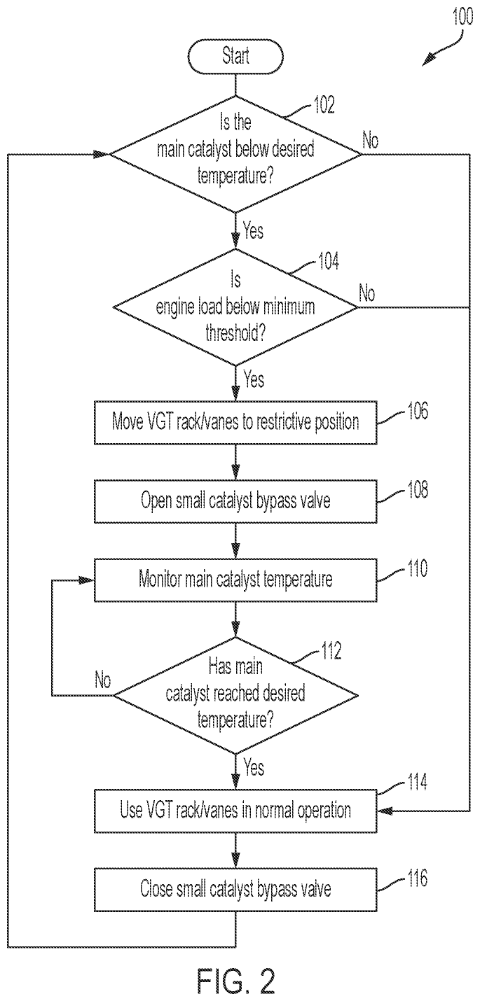

With reference now to FIG. 2, a flow diagram of an example method 100 of operating the engine system 10 is illustrated. At step 102, controller 60 (control) determines if the main catalyst 42 is below a predetermined light-off temperature. If no, control proceeds to step 114. If yes, control proceeds to step 104 and determines if an engine load is below a minimum threshold (e.g., a load/flow the bypass passage 50 can handle). If no, control proceeds to step 114. If yes, control proceeds to step 106 and moves the VGT vanes 38 to the restricted position.

At step 108, control opens the bypass valve 54 to allow exhaust to pass through the bypass passage 50. At step 110, control monitors the temperature of the main catalyst 42. At step 112, control determines if the main catalyst 42 has reached the predetermined light-off temperature. If no, control returns to step 110. If yes, control proceeds to step 114 and moves the VGT vanes 38 to the normal position. At step 116, control closes the bypass valve 54. Control then ends or returns to step 102.

Described herein are systems and methods for improving vehicle emissions systems efficiency, particularly during cold start, long idle, and low main catalyst temperature conditions. The system includes a light-off catalyst bypass system with a small catalyst to receive exhaust flow during light-off (start-up), extended idle, some low load conditions, or other conditions. A VGT turning includes vanes selectively movable to a restricted position to direct the exhaust flow through the catalyst bypass system. A bypass valve selectively blocks flow to the small catalyst when the main catalyst has reached light-off temperature.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

1. An internal combustion engine system, comprising:
an internal combustion engine having a cylinder head;
a main exhaust aftertreatment system with a main catalytic converter configured to receive exhaust gas from the internal combustion engine;
a variable geometry turbocharger (VGT) turbine having a plurality of vanes movable between a normal operation position and a restricted position; and
a light-off catalyst bypass system integrated into the cylinder head with a bypass passage formed within the cylinder head and a bypass catalytic converter disposed within the cylinder head and configured to selectively receive exhaust gas from the internal combustion engine and bypass the VGT turbine,
wherein during cold start, long idle, and/or low main catalytic converter temperature conditions, the plurality of vanes are moved to the restricted position to restrict or prevent exhaust gas from flowing through the VGT turbine to facilitate directing the exhaust gas through the bypass passage and the bypass catalyst.

2. The internal combustion engine system of claim 1, further comprising an exhaust manifold configured to supply exhaust gas through a main outlet duct, through the VGT turbine, and to the main exhaust aftertreatment system and the main catalytic converter,
wherein the bypass passage is in fluid communication with the exhaust manifold.

3. The internal combustion engine system of claim 2, further comprising a bypass valve configured to move between a first position that enables exhaust gas to flow through the bypass passage, and a second position that prevents exhaust gas flow through the bypass passage and bypass catalytic converter.

4. The internal combustion engine system of claim 3, wherein the bypass valve is moved to the first position when the plurality of vanes is moved to the restricted position.

5. The internal combustion engine system of claim 3, wherein the bypass valve is moved to the second position when the plurality of vanes is moved to the normal operation position.

6. The internal combustion engine system of claim 3, further comprising a controller in signal communication with the VGT and configured to move the plurality of vanes between the restricted position and the normal operation position.

7. The internal combustion engine system of claim 6, wherein the controller is in signal communication with the bypass valve and configured to move the bypass valve between the first and second positions.

8. The internal combustion engine system of claim 1, wherein the restricted position prevents flow of exhaust gas through the VGT turbine.

9. A method of operating an internal combustion engine system that comprises:
an internal combustion engine having a cylinder head;
a main exhaust aftertreatment system with a main catalytic converter configured to receive exhaust gas from the internal combustion engine;
a variable geometry turbocharger (VGT) turbine having a plurality of vanes movable between a normal operation position and a restricted position; and
a light-off catalyst bypass system integrated into the cylinder head with a bypass passage formed within the cylinder head and a bypass catalytic converter disposed within the cylinder head and configured to selectively receive exhaust gas from the internal combustion engine and bypass the VGT turbine, the method comprising:
monitoring, by a controller having one or more processors, a temperature of the main catalytic converter to determine if the temperature is below a predetermined light-off temperature; and
moving, by the controller, the plurality of vanes to the restricted position when the temperature is below the predetermined light-off temperature to restrict or prevent exhaust gas from flowing through the VGT turbine to facilitate directing the exhaust gas through the bypass passage and the bypass catalyst.

10. The method of claim 9, wherein the internal combustion engine system further includes an exhaust manifold configured to supply exhaust gas through a main outlet duct, through the VGT turbine, and to the main exhaust aftertreatment system and the main catalytic converter,
wherein the bypass passage is in fluid communication with the exhaust manifold.

11. The method of claim 10, wherein the internal combustion engine system further includes a bypass valve configured to move between a first position that enables exhaust gas to flow through the bypass passage, and a second position that prevents exhaust gas flow through the bypass passage and bypass catalytic converter.

12. The method of claim 11, further comprising:
moving the bypass valve, by the controller, to the first position when the temperature is below the predetermined light-off temperature to enable exhaust gas to flow through the bypass passage.

13. The method of claim 11, further comprising:
moving the bypass valve, by the controller, to the second position when the temperature exceeds the predetermined light-off temperature to prevent exhaust gas to flow through the bypass passage.

14. The method of claim 13, further comprising:
moving the plurality of vanes, by the controller, to the normal operating position when the temperature exceeds the predetermined light-off temperature to enable exhaust gas to flow through the VGT turbine.

15. The method of claim 9, wherein the restricted position prevents flow of exhaust gas through the VGT turbine.

16. The method of claim 9, wherein the bypass catalytic converter is a three-way catalyst configured to convert and remove CO, HC, and NOx from exhaust gas passing therethrough.

17. The internal combustion engine system of claim 1, wherein the bypass catalytic converter is a three-way catalyst configured to convert and remove CO, HC, and NOx from exhaust gas passing therethrough.
